(19) United States
(12) Patent Application Publication
(10) Pub. No.: US 2013/0289974 A1
(43) Pub. Date: Oct. 31, 2013

(54) CHINESE CHARACTER INFORMATION PROCESSING METHOD AND CHINESE CHARACTER INFORMATION PROCESSING DEVICE

(71) Applicant: Zuhui Yue, Beijing (CN)

(72) Inventor: Zuhui Yue, Beijing (CN)

(73) Assignee: CHINA MOBILE COMMUNICATIONS CORPORATION, Beijing (CN)

(21) Appl. No.: 13/993,116

(22) PCT Filed: Jan. 4, 2012
(86) PCT No.: PCT/CN2012/000003

§ 371 Date: Jun. 11, 2013

(30) Foreign Application Priority Data
Jan. 4, 2011 (CN) 201110000513.9

(51) Int. Cl. G06F 17/28

(52) U.S. Cl. CPC G06F 17/289
USPC 704/8

(57) ABSTRACT

A Chinese character information processing method and a Chinese character information processing device. The method comprises: an application determining a machine code of a Chinese character inputted by a user; determining Chinese character information of the Chinese character inputted by the user according to a correlation between a pre-stored machine code and pre-stored Chinese character information, the Chinese character information comprising a pronunciation of the Chinese character inputted by the user; when determining that the number of pronunciations of the Chinese character is multiple according to the Chinese character information of the Chinese character inputted by the user, determining a current pronunciation of the Chinese character inputted by the user from the multiple pronunciations; and storing the Chinese character information comprising the pronunciation being the determined current pronunciation and the machine code of the Chinese character. With the technical solution, when Chinese character information is stored in an application, a polyphonic character may be distinguished.

This application claims priority to Chinese patent application No. 201110000513.9 titled “CHINESE CHARACTER INFORMATION PROCESSING METHOD AND CHINESE CHARACTER INFORMATION PROCESSING DEVICE” and filed with the State Intellectual Property Office on Jan. 4, 2011, which is incorporated herein by reference in its entirety.

### FIELD OF THE INVENTION

The present invention relates to the field of information processing, and particularly to a Chinese character information processing method and Chinese character information processing device.

### BACKGROUND OF THE INVENTION

Chinese character is a type of non-spelling character which is very widely used at present. In accordance with National Standard (GB) code, each Chinese character has a determined binary code, which is referred to as a machine code of the Chinese character. The machine codes of Chinese characters, which are in a one-to-one correspondence with the Chinese characters, are used as identifiers of the Chinese characters for processing of Chinese character information, such as storage, display, and transmission. Currently, a commonly used machine code of a Chinese character is derived from adding 1 to the first bit of each byte of the GB code. And when processed by a computer, a code is determined as a machine code of a Chinese character if the first bit of the code is “1”.

Chinese character is widely used in various fields. Generally, people use Chinese character to represent information needed to express, or to record events, e.g., information stored in an application such as Word, Excel and txt and represented by Chinese character, contact name information stored in a mobile terminal and recorded by Chinese character. Currently, as shown in FIG. 1, a general process of storing Chinese character information in individual applications mainly includes the following steps.

Step 101, receiving a Chinese character inputted by a user via an application.

The user may input the Chinese character in various ways, such as a phonetic input method, a natural code input method, a pictographic code input method and a five pen shaped input method. Generally, the received Chinese character inputted by the user is represented by an external code (also known as an input code) of the Chinese character. Specifically, the external code of the Chinese character is a set of keyboard symbols for inputting the Chinese character into the computer.

Step 102, determining a corresponding machine code of the Chinese character in an operating system.

In this step, the corresponding machine code of the Chinese character in the operating system is determined by converting the input code of the Chinese character into a machine code.

Step 103, storing the determined machine code.

With the above process, storage of Chinese characters inputted via an application can be realized. As can be seen, in the prior art, storing various information represented by Chinese character in an application is substantially achieved by storing machine codes of the Chinese characters. However, in practical applications, there are a large number of polyphonic Chinese characters. For example, a polyphonic Chinese character “ [symbol] ” has multiple pronunciations, corresponding pronunciations thereof are “le (the fourth tone)” and “yue (the fourth tone)”. It follows that, by the method for storing Chinese character in an application in the prior art, a polyphonic character in Chinese character can not be distinguished, e.g., a specific pronunciation corresponding to a polyphonic character currently stored can not be distinguished.

### SUMMARY OF THE INVENTION

In view of the above, the embodiments of the invention provide a Chinese character information processing method and Chinese character information processing device. By using the technical solutions to store Chinese character information in an application, a polyphonic character in the Chinese character can be distinguished, thereby improving the accuracy rate of identifying a pronunciation of a Chinese character in the procedure in which the application processes a Chinese character.

The embodiments of the invention are achieved by the following technical solutions.

According to an aspect of the embodiments of the invention, there is provided a Chinese character information processing method.

The Chinese character information processing method according to an embodiment of the invention includes:

determining by an application a machine code of a Chinese character inputted by a user;

determining Chinese character information of the Chinese character inputted by the user according to a stored correspondence between a machine code and Chinese character information of a Chinese character corresponding to the machine code, the Chinese character information including a pronunciation of the Chinese character;

when it is determined according to the Chinese character information of the Chinese character inputted by the user that the Chinese character has a plurality of pronunciations, determining a current pronunciation of the Chinese character inputted by the user from the plurality of pronunciations; and

storing the machine code of the Chinese character and the Chinese character information including a pronunciation which is the determined current pronunciation.

According to another aspect of the embodiments of the invention, there is provided a Chinese character information processing device.

The Chinese character information processing device according to an embodiment of the invention includes:

a machine code determining unit, configured to determine a machine code of a Chinese character inputted by a user;

a Chinese character information determining unit, configured to determine, according to a stored correspondence between a machine code and Chinese character information of a Chinese character corresponding to the machine code, Chinese character information of the Chinese character corresponding to the machine code determined by the machine code determining unit, the Chinese character information including a pronunciation of the Chinese character;

a current pronunciation determining unit, configured to determine a current pronunciation of the Chinese character inputted by the user from a plurality of pronunciations when it is determined according to the Chinese character information determined by the Chinese character information determining unit that the Chinese character inputted by the user has the plurality of pronunciations; and

a Chinese character storage unit, configured to store the machine code of the Chinese character determined by the machine code determining unit and the Chinese character information including a pronunciation being the current pronunciation determined by the current pronunciation determining unit.

By at least one of the above-mentioned technical solutions according to the embodiments of the invention, an application determines a machine code of a Chinese character inputted by a user; determines Chinese character information of the Chinese character inputted by the user according to a stored correspondence between a machine code and Chinese character information of the Chinese character corresponding to the machine code, the Chinese character information includes a pronunciation of the Chinese character; and determines a current pronunciation of the Chinese character inputted by the user from a plurality of pronunciations when it is determined according to the Chinese character information that the Chinese character has the plurality of pronunciations, and stores the machine code of the Chinese character and the Chinese character information including a pronunciation which is the determined current pronunciation. According to the technical solution, Chinese character information including the current pronunciation of a Chinese character can be further stored in addition to storing the machine code of the Chinese character, therefore, a polyphonic character can be distinguished through the stored Chinese character information.

Other features and advantages of the invention will be set forth in the specification which follows, and in part will be obvious from the specification, or may be known by implementing the present invention. Objectives and other advantages of the present invention may be realized and obtained by the structure particularly pointed out in the specification, the claims and the drawings.

### BRIEF DESCRIPTION OF THE DRAWINGS

The drawings are to provide a further understanding of the invention and constitute a part of the specification, and are used to explain the present invention together with embodiments of the invention without limiting the invention. In the drawings:

FIG. 1 is a flowchart of storing a Chinese character inputted by a user according to the prior art;

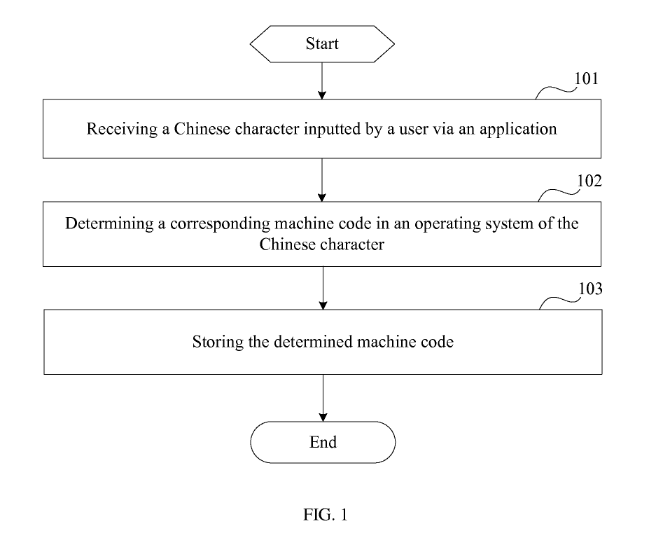

FIG. 2 is a flowchart of storing a Chinese character according to a first embodiment of the invention;

FIG. 3 is a flowchart of displaying a stored Chinese character according to the first embodiment of the invention; and

FIG. 4 is a schematic diagram of an information storage device according to a second embodiment of the invention.

### DETAILED DESCRIPTION OF THE INVENTION

In order to provide an implementation scheme for distinguishing a polyphonic character when storing Chinese character information in an application, the embodiments of the invention provide a Chinese character information processing method and Chinese character information processing device. In the following, preferred embodiments of the invention will be described in conjunction with the drawings of the specification. It is to be understood that the preferred embodiments of the invention described herein are only to illustrate and explain the present invention, which shall not be interpreted as limiting the scope of the present invention. Furthermore, if not conflicting, the embodiments of the present application and the features in the embodiments can be combined with one another.

### A First Embodiment

The first embodiment of the invention provides a Chinese character information processing method. The method may be performed internally of an application, for example, in an application such as Outlook, an address book of mobile phone contacts, Word, Excel and txt. By storing a Chinese character inputted by the user via the application with a Chinese character storage method according to the embodiment, a polyphonic character can be distinguished in the process of storage.

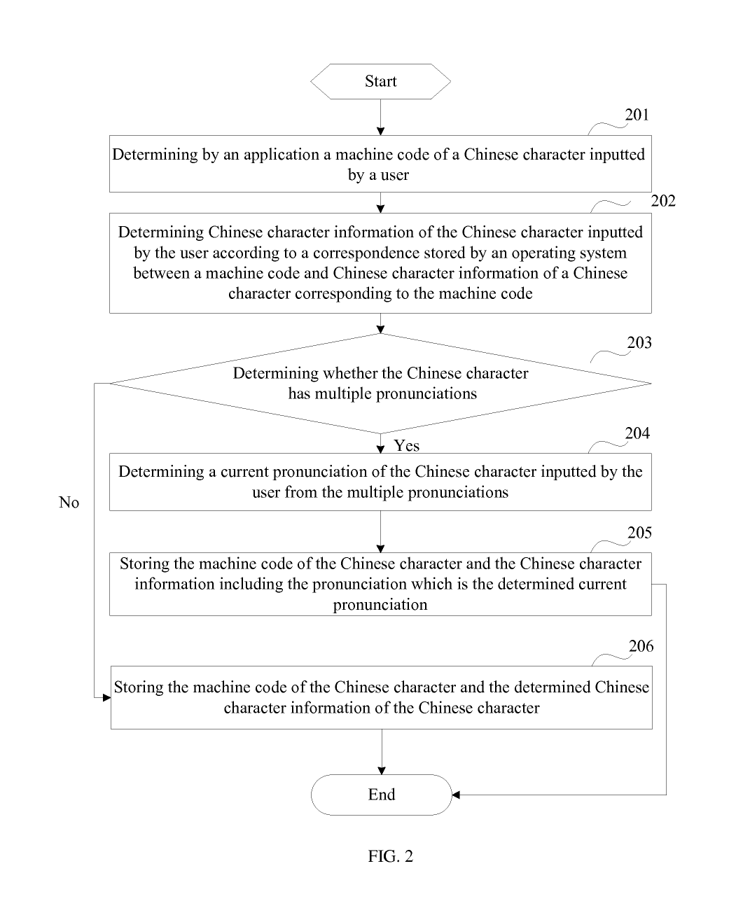

As shown in FIG. 2, the Chinese character information processing method according to the first embodiment of the invention mainly includes the following steps:

step 201, determining, by an application, a machine code of a Chinese character inputted by a user;

step 202, determining Chinese character information of the Chinese character inputted by the user according to a correspondence stored in an operating system between a machine code and Chinese character information of a Chinese character corresponding to the machine code, wherein the Chinese character information including a pronunciation of the Chinese character;

step 203, determining whether the Chinese character has a plurality of pronunciations according to the Chinese character information of the Chinese character inputted by the user, and if the Chinese character has a plurality of pronunciations, performing step 204 to step 205; otherwise, performing step 206;

step 204, determining a current pronunciation of the Chinese character inputted by the user from the plurality of pronunciations;

step 205, storing the machine code of the Chinese character and the Chinese character information including a pronunciation which is the determined current pronunciation, and ending the process of storing the Chinese character inputted by the user; and

step 206, storing the machine code of the Chinese character and the determined Chinese character information of the Chinese character, and ending the process of storing the Chinese character inputted by the user.

By execution of the process shown in FIG. 2, Chinese character information of a Chinese character including at least a pronunciation is stored at the same time in addition to storing the machine code of the Chinese character, thereby distinguishing of a polyphonic character can be obtained.

In the first embodiment of the invention, in order to store Chinese character information inputted by a user for different applications, in addition to the machine code of a Chinese character, Chinese character information of the Chinese character is also stored in the operating system. The Chinese character information includes at least a pronunciation of the Chinese character, and in the case where the Chinese character is a polyphonic character, the multiple pronunciations are stored. On this basis, information such as a tone corresponding to the pronunciation of the Chinese character and/or the number of strokes may be further stored.

An example of storing a Chinese character in the operating system is described as follows.

| | | | | Number |
|---|---|---|---|---|
| Chinese Character | Machine Code | Pronunciation | Tone | of strokes |
| [symbol] | 0xC0D6 | yue | 4 | 5 |
| | | le | 4 | |

In the table above, the tone and the number of strokes may be stored selectively.

The first embodiment of the invention also provides a preferred implementation corresponding to above step 204, that is, a preferred implementation for determining a current pronunciation of the Chinese character inputted by the user from the plurality of pronunciations. Specifically, the current pronunciation of the Chinese character inputted by the user may be determined in following ways.

### First Way:

The plurality of pronunciations are displayed to the user, and a pronunciation selected by the user from the displayed plurality of pronunciations is determined as the current pronunciation. In the first way, the current pronunciation of the Chinese character is selected by the user who inputs the Chinese character.

### Second Way:

According to a context of the Chinese character inputted by the user, a pronunciation of the Chinese character in the context is determined from the plurality of pronunciations as the current pronunciation. In order to support this way, pronunciations of a polyphonic character in different contexts may be pre-stored. For example, for the polyphonic character “ [symbol] ”, it is pronounced “le” in “ [symbol] [symbol] ”, and it is pronounced “yue” in “ [symbol] [symbol] ”. With storing of such information, a current pronunciation of the Chinese character can be determined according to the context of the Chinese character inputted by a user.

In the first embodiment of the invention, Chinese character information of a Chinese character stored according to the process shown in FIG. 2 may include only a pronunciation of the Chinese character. In the case where the Chinese character is a polyphonic character, the pronunciation of the Chinese character included in the Chinese character information is the determined current pronunciation. For example, for the Chinese character “ [symbol] ”, two pronunciations are stored in the operating system, as shown in the table below.

| Chinese Character | Machine Code | Pronunciation |
|---|---|---|
| [symbol] | 0xC0D6 | yue |
| | | le |

If a current pronunciation of “ [symbol] ” inputted by a user is determined according to the flow shown in FIG. 2 as “yue”, then the information stored according to the process shown in FIG. 2 of the first embodiment of the invention for “ [symbol] ” inputted by the user may include:

| Chinese Character | Machine Code | Pronunciation |
|---|---|---|
| [symbol] | 0xC0D6 | yue |

On this basis, if the Chinese character information stored in the operating system also includes tone information and/or information about the number of strokes of the Chinese character, the Chinese character information stored according to the flow shown in FIG. 2 may further include the tone information and/or information about the number of strokes of the Chinese character. For example, in the case where tone information and/or information about the number of strokes of “ [symbol] ” are stored in an operating system, according to the process shown in FIG. 2 of the first embodiment of the invention, the stored information for “ [symbol] ” is shown in the following table (wherein the determined current pronunciation is “yue”):

| | | | | The number |
|---|---|---|---|---|
| Chinese Character | Machine Code | Pronunciation | Tone | of strokes |
| [symbol] | 0xC0D6 | yue | 4 | 5 |

According to the above technical solution in the first embodiment of the invention, the Chinese character information including the pronunciation and other information of the Chinese character is stored at the same time in addition to storing by the application the Chinese character inputted by the user. Therefore, in order to support a function of help-reading of Chinese character information when displaying the Chinese character information, specifically the following steps are further performed before performing the above step 205 or step 206, that is, before storing the Chinese character information and the machine code of the Chinese character:

determining whether to display the Chinese character information of the Chinese character along with displaying the Chinese character, and storing the determination information on whether to display the Chinese character information of the Chinese character when storing the Chinese character information and the machine code of the Chinese character.

Specifically, the way of determining whether to display the Chinese character information of the Chinese character along with displaying the Chinese character is as follows:

a user is prompted to select whether to display the Chinese character information of the Chinese character, and the selection results of the user is received.

According to the above preferred embodiment, stored information for a Chinese character inputted by a user such as “ [symbol] ” is shown as the following table (wherein the current pronunciation is “yue”).

| | | | | | Whether |
|---|---|---|---|---|---|
| | | | | | to display |
| | | | | | the Chinese |
| Chinese | Machine | Pronun- | | The number | character |
| Character | Code | ciation | Tone | of strokes | information |
| [symbol] | 0xC0D6 | yue | 4 | 5 | Yes |

In the above table, the information on whether to display the Chinese character information may be determination information of “Yes” or “No”, and may also be Chinese character information selected to be displayed. For example, in the case when a user expects to only display a pronunciation, the information on whether to display the Chinese character information may be “display a pronunciation”; in the case when the user expects to display a pronunciation and a tone, the information on whether to display the Chinese character information may be “display a pronunciation and a tone”.

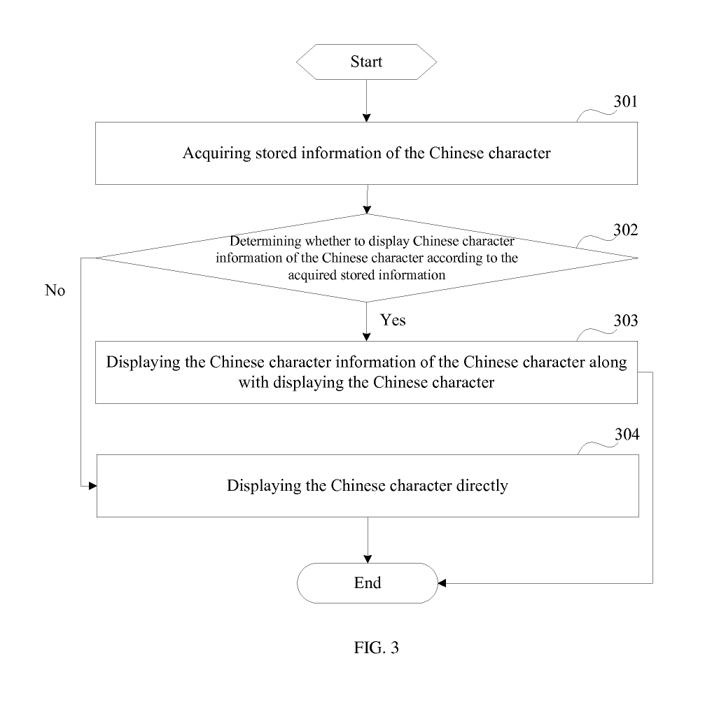

According to the above preferred embodiment of storing information on whether to display the Chinese character information, the displaying a Chinese character, as shown in FIG. 3, mainly includes the following steps:

step 301, acquiring stored information of a Chinese character;

in the step 301, the acquired stored information of the Chinese character includes Chinese character information, a machine code of the Chinese character, and determination information on whether to display the Chinese character information;

step 302, determining whether to display the Chinese character information of the Chinese character according to the acquired stored information, if it is to display the Chinese character information of the Chinese character, performing step 303; otherwise, performing step 304;

step 303, displaying the Chinese character information of the Chinese character along with displaying the Chinese character, and ending the process; and

step 304, displaying the Chinese character directly, and ending the process.

According to the process shown in FIG. 3, in the case wherein the user chooses to display Chinese character information of the Chinese character, the ways of displaying the stored “ [symbol] ” may be as shown in the table below.

| Context | Way of Displaying 1 | Way of Displaying 2 |
|---|---|---|
| [symbol] [symbol] | [symbol] [symbol] (yue) | [symbol] [symbol] (yuè) |
| [symbol] [symbol] | [symbol] [symbol] (le) | [symbol] [symbol] (lè) |

In a preferred embodiment according to the embodiments of the invention, Chinese characters may also be sorted according to stored Chinese character information. Specifically, Chinese character information and a machine code of a Chinese character may be stored in the following ways:

determining, according to the Chinese character information of the Chinese character, the sorting sequence of the Chinese character information of the Chinese character in stored Chinese character information of Chinese characters, and storing the Chinese character information and the machine code of the Chinese character according to the determined sorting sequence;

or

determining, according to the machine code of the Chinese character, the sorting sequence of the machine code of the Chinese character in stored machine codes of Chinese characters, and storing the Chinese character information and the machine code of the Chinese character according to the determined sorting sequence.

In the above preferred embodiment, the steps of determining, according to the Chinese character information of the Chinese character, the sorting sequence of the Chinese character information of the Chinese character in stored Chinese character information of Chinese characters, may be performed in accordance with various sorting rules. For example, the Chinese character information may be sorted in accordance with a phonetic sequence table according to the pronunciation in the Chinese character information of the Chinese character; or the Chinese character information may be sorted in accordance with tones according to the tone included in the Chinese character information of the Chinese character; or the Chinese character information may be sorted in accordance with the number of strokes from more to less or from less to more according to the number of strokes included in the Chinese character information of the Chinese character. The specific sorting rule may be determined flexibly as required, which would not be listed one by one herein.

### Second Embodiment

The second embodiment of the invention provides a Chinese character information processing device. A Chinese character is stored by the processing device so that a polyphonic character can be distinguished.

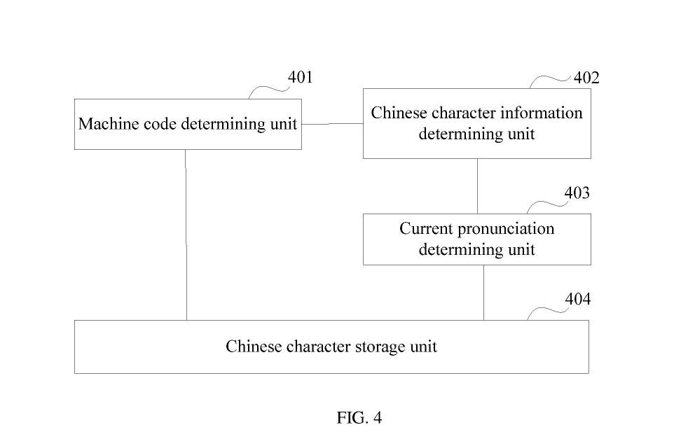

As shown in FIG. 4, an information processing device provided by the second embodiment of the invention mainly includes:

a machine code determining unit 401, a Chinese character information determining unit 402, a current pronunciation determining unit 403 and a Chinese character storage unit 404;

in which,

the machine code determining unit 401 is configured to determine a machine code of a Chinese character inputted by a user;

the Chinese character information determining unit 402 is configured to determine, according to a correspondence stored by an operating system between a machine code and Chinese character information of the Chinese character corresponding to the machine code, Chinese character information of the Chinese character corresponding to the machine code determined by the machine code determining unit 401, the Chinese character information including a pronunciation of the Chinese character;

the current pronunciation determining unit 403 is configured to determine a current pronunciation of the Chinese character inputted by the user from a plurality of pronunciations when it is determined according to the Chinese character information determined by the Chinese character information determining unit 402 that the Chinese character inputted by the user has the plurality of pronunciations; and

the Chinese character storage unit 404 is configured to store the machine code of the Chinese character determined by the machine code determining unit 401 and the Chinese character information including a pronunciation which is the pronunciation determined as the current pronunciation by the current pronunciation determining unit 403.

In a preferred implementation according to the second embodiment of the invention, the current pronunciation determining unit 403 included in the device shown in FIG. 4 is specifically configured to:

display the plurality of pronunciations of the Chinese character to the user, and determine a pronunciation selected by the user from the displayed plurality of pronunciations as the current pronunciation;

or

determine, according to a context of the Chinese character inputted by the user, a pronunciation of the Chinese character in the context from the plurality of pronunciations of the Chinese character as the current pronunciation.

In a preferred implementation according to the second embodiment of the invention, the Chinese character information determining unit 402 included in the device shown in FIG. 4 is specifically configured to:

determine Chinese character information of the Chinese character corresponding to the machine code determined by the machine code determining unit 401 according to a correspondence stored by an operating system between a machine code and Chinese character information of the Chinese character corresponding to the machine code, the Chinese character information including a pronunciation of the Chinese character, and also including a tone and/or the number of strokes of the Chinese character.

In a preferred implement according to the second embodiment of the invention, the Chinese character storage unit 404 included in the device shown in FIG. 4 is further configured to:

determine whether to display the Chinese character information of the Chinese character along with displaying the Chinese character, and store the determination information on whether to display the Chinese character information of the Chinese character along with storing the machine code of the Chinese character and the Chinese character information including a pronunciation which is the determined current pronunciation.

In a preferred implement according to the second embodiment of the invention, the Chinese character storage unit 404 included in the device shown in FIG. 4 is specifically configured to:

determine the sorting sequence of the Chinese character information of the Chinese character in stored Chinese character information of Chinese characters according to the Chinese character information determined by the Chinese character information determining unit 402, and store the machine code of the Chinese character and the Chinese character information including a pronunciation which is the determined current pronunciation according to the determined sorting sequence; or

determine the sorting sequence of the machine code of the Chinese character in stored machine codes of Chinese characters according to the machine code of the Chinese character determined by the machine code determining unit 401, and store the machine code of the Chinese character and the Chinese character information including a pronunciation which is the determined current pronunciation according to the determined sorting sequence.

It is to be understood that the above units included in the Chinese character information processing device are only divided logically according to functions achieved by the device. In practical applications, the above units may be combined or split. The functions achieved by the Chinese character information processing device according to the second embodiment of the invention is in one to one correspondence with the process of the Chinese character information processing method according to the above first embodiment of the invention. For a more detailed processing flow achieved by the device, the detailed description is made in the above first embodiment, and therefore it will not be repeated herein.

By at least one of the above-mentioned technical solution according to the embodiments of the invention, an application determines a machine code of a Chinese character inputted by a user; determines Chinese character information of the Chinese character inputted by the user according to a stored correspondence in a operating system between a machine code and Chinese character information of the Chinese character corresponding to the machine code, the Chinese character information including a pronunciation of the Chinese character; and determines a current pronunciation of the Chinese character inputted by the user from a plurality of pronunciations when it is determined according to the Chinese character information that the Chinese character has the plurality of pronunciations, and stores the Chinese character information including the matching code of the Chinese character and a pronunciation which is the determined current pronunciation. According to the technical solution, the Chinese character information including the current pronunciation of a Chinese character can be further stored in addition to storing the machine code of the Chinese character, thereby a polyphonic character can be distinguished through the stored Chinese character information.

It will be apparent to the skilled in the art that various changes and modifications may be made to the invention without departing from the spirit and scope of the invention. Therefore, provided that these changes and modifications of the invention are within the scope of the claims and equivalent techniques of the invention, the invention also includes these changes and modifications.

1. A Chinese character information processing method, comprising:
determining a machine code of a Chinese character inputted by a user;
determining Chinese character information of the Chinese character inputted by the user according to a pre-stored correspondence between a machine code and Chinese character information, the Chinese character information comprising a pronunciation of the Chinese character;
when it is determined according to the determined Chinese character information that the Chinese character inputted by the user has a plurality of pronunciations, determining a current pronunciation of the Chinese character inputted by the user from the plurality of pronunciations; and
storing the machine code and the Chinese character information comprising the current pronunciation of the Chinese character inputted by the user.

2. The method according to claim 1, wherein the determining a current pronunciation of the Chinese character inputted by the user from the plurality of pronunciations comprises:
displaying the plurality of pronunciations to the user, and determining a pronunciation selected by the user from the displayed plurality of pronunciations as the current pronunciation; or
determining, according to a context of the Chinese character inputted by the user, a pronunciation of the Chinese character inputted by the user in the context from the plurality of pronunciations as the current pronunciation.

3. The method according to claim 1, wherein the Chinese character information further comprises a tone and/or the number of strokes of the Chinese character.

4. The method according to claim 1, wherein, before the storing the machine code and the Chinese character information comprising the current pronunciation of the Chinese character inputted by the user, the method further comprises:
determining whether to display the Chinese character information comprising the current pronunciation of the Chinese character inputted by the user along with displaying the Chinese character inputted by the user, and
storing determination information on whether to display the Chinese character information comprising the current pronunciation of the Chinese character inputted by the user when storing the machine code and the Chinese character information comprising the current pronunciation of the Chinese character inputted by the user.

5. The method according to claim 1, wherein the storing the machine code and the Chinese character information comprising the current pronunciation of the Chinese character inputted by the user comprises:
determining the sorting sequence of the Chinese character information of the Chinese character inputted by the user in stored Chinese character information of Chinese characters according to the Chinese character information of the Chinese character, and storing the machine code and the Chinese character information comprising the current pronunciation of the Chinese character inputted by the user according to the determined sorting sequence; or
determining the sorting sequence of the machine code of the Chinese character inputted by the user in stored machine codes of Chinese characters according to the machine code of the Chinese character inputted by the user, and storing the machine code and the Chinese character information comprising the current pronunciation of the Chinese character inputted by the user according to the determined sorting sequence.

6. A Chinese character information processing device, comprising:
a machine code determining unit, configured to determine a machine code of a Chinese character inputted by a user;
a Chinese character information determining unit, configured to determine, according to a pre-stored correspondence between a machine code and Chinese character information, Chinese character information of the Chinese character inputted by the user corresponding to the machine code determined by the machine code determining unit, the Chinese character information comprising a pronunciation of the Chinese character;
a current pronunciation determining unit, configured to determine a current pronunciation of the Chinese character inputted by the user from a plurality of pronunciations when it is determined according to the Chinese character information determined by the Chinese character information determining unit that the Chinese character inputted by the user has the plurality of pronunciations; and
a Chinese character storage unit, configured to store the machine code of the Chinese character determined by the machine code determining unit and the Chinese character information comprising the current pronunciation determined by the current pronunciation determining unit.

7. The device according to claim 6, wherein the current pronunciation determining unit is specifically configured to:
display the plurality of pronunciations of the Chinese character to the user, and determine a pronunciation selected by the user from the displayed plurality of pronunciations as the current pronunciation;
or
determine, according to a context of the Chinese character inputted by the user, a pronunciation of the Chinese character inputted by the user in the context from the plurality of pronunciations of the Chinese character as the current pronunciation.

8. The device according to claim 6, wherein the Chinese character information determining unit is specifically configured to:
determine the Chinese character information of the Chinese character inputted by the user corresponding to the machine code determined by the machine code determining unit according to a pre-stored correspondence between a machine code and Chinese character information, the Chinese character information of the Chinese character inputted by the user comprising a pronunciation of the Chinese character, and a tone and/or the number of strokes of the Chinese character.

9. The device according to claim 6, wherein the Chinese character storage unit is further configured to:
determine whether to display the Chinese character information comprising the current pronunciation of the Chinese character inputted by the user along with displaying the Chinese character inputted by the user, and store determination information on whether to display the Chinese character information comprising the current pronunciation of the Chinese character inputted by the user along with storing the machine code and the Chinese character information comprising the current pronunciation of the Chinese character inputted by the user.

10. The device according to claim 6, wherein the Chinese character storage unit is specifically configured to:
determine the sorting sequence of the Chinese character information of the Chinese character inputted by the user in stored Chinese character information of Chinese characters according to the Chinese character information determined by the Chinese character information determining unit, and store the machine code and the Chinese character information comprising the current pronunciation of the Chinese character inputted by the user according to the determined sorting sequence; or
determine the sorting sequence of the machine code of the Chinese character inputted by the user in stored machine codes of Chinese characters according to the machine code of the Chinese character inputted by the user determined by the machine code determining unit, and store the machine code and the Chinese character information comprising a pronunciation which is the determined current pronunciation of the Chinese character according to the determined sorting sequence.

11. The method according to claim 3, wherein, before the storing the machine code and the Chinese character information comprising the current pronunciation of the Chinese character inputted by the user, the method further comprises:
determining whether to display the Chinese character information comprising the current pronunciation of the Chinese character inputted by the user along with displaying the Chinese character inputted by the user, and
storing determination information on whether to display the Chinese character information comprising the current pronunciation of the Chinese character inputted by the user when storing the machine code and the Chinese character information comprising the current pronunciation of the Chinese character inputted by the user.

12. The method according to claim 3, wherein the storing the machine code and the Chinese character information comprising the current pronunciation of the Chinese character inputted by the user comprises:
determining the sorting sequence of the Chinese character information of the Chinese character inputted by the user in stored Chinese character information of Chinese characters according to the Chinese character information of the Chinese character, and storing the machine code and the Chinese character information comprising the current pronunciation of the Chinese character inputted by the user according to the determined sorting sequence; or
determining the sorting sequence of the machine code of the Chinese character inputted by the user in stored machine codes of Chinese characters according to the machine code of the Chinese character inputted by the user, and storing the machine code and the Chinese character information comprising the current pronunciation of the Chinese character inputted by the user according to the determined sorting sequence.

13. The device according to claim 8, wherein the Chinese character storage unit is further configured to:
determine whether to display the Chinese character information comprising the current pronunciation of the Chinese character inputted by the user along with displaying the Chinese character inputted by the user, and store determination information on whether to display the Chinese character information comprising the current pronunciation of the Chinese character inputted by the user along with storing the machine code and the Chinese character information comprising the current pronunciation of the Chinese character inputted by the user.

14. The device according to claim 8, wherein the Chinese character storage unit is specifically configured to:
determine the sorting sequence of the Chinese character information of the Chinese character inputted by the user in stored Chinese character information of Chinese characters according to the Chinese character information determined by the Chinese character information determining unit, and store the machine code and the Chinese character information comprising the current pronunciation of the Chinese character inputted by the user according to the determined sorting sequence; or
determine the sorting sequence of the machine code of the Chinese character inputted by the user in stored machine codes of Chinese characters according to the machine code of the Chinese character inputted by the user determined by the machine code determining unit, and store the machine code and the Chinese character information comprising a pronunciation which is the determined current pronunciation of the Chinese character according to the determined sorting sequence.
